(19) United States
(12) Patent Application Publication
(10) Pub. No.: US 2015/0066210 A1
(43) Pub. Date: Mar. 5, 2015

(54) Remote Wireless Communication Control System for Submerged Arc Furnace Reactive Compensation

(71) Applicant: Guangxi Maisha Electric Group Co., Ltd., Guangxi Zhuang Autonomous Region (CN)

(72) Inventor: Jianle You, Zhejiang (CN)

(21) Appl. No.: 14/469,966

(22) Filed: Aug. 27, 2014

(30) Foreign Application Priority Data
Aug. 27, 2013 (CN) 201310377398.6

(51) Int. Cl. F27D 19/00; H04W 4/00; G05B 19/05; H05B 7/148; F27D 21/02

(52) U.S. Cl. CPC F27D 19/00; H05B 7/148; F27D 21/02; G05B 19/05; H04W 4/005; F27D 2021/0057
USPC 700/274

(57) ABSTRACT

The present invention relates to a remote wireless communication control system for submerged arc furnace reactive compensation. The system includes a remote wireless communication control machine and a submerged arc furnace reactive compensation device. The remote wireless communication control machine further includes a MS-RSCM302 security communication module integrated with a MS-3G network communication module, and a MS-NC2 serial port conversion module. The submerged arc furnace reactive compensation device includes a control cabinet and a capacitance automatic compensation cabinet. The control cabinet comprises a MS-RSCM302 security communication module, a MS-NC2 serial port conversion module, a DVPEH2 PLC controller, a programmable multi-function network instrument and a touch screen; while the capacitance automatic compensation cabinet comprises multiple compensation units. The present invention performs remote Internet communication and data collection via cable modem, wireless transmission and 3G, while remote monitoring and data reading on each site are realized through installation of customized software in the computers and smart phones, to further remotely manage the actual operation status of the submerged arc furnace reactive compensation device and to solve such maintenance burdens as tedious on-site maintenance and long maintenance time.

### TECHNOLOGICAL FIELD OF THE INVENTION

The present invention relates to a control device system of electric submerged arc furnace and, more particularly, to a kind of remote wireless communication control system for submerged arc furnace reactive compensation.

### BACKGROUND TECHNOLOGY OF THE INVENTION

The existing technology of submerged arc furnace power compensation device generally requires on-site supervision and debugging to control by workers. Since this kind of traditional device requires technicians for on-site operation and implementing point-to-point supervision operation, furthermore, no given complete ancillary control system has been researched and developed yet, it takes much more working time of the technicians, which results in low work efficiency. Additionally, with failure to timely detect and handle the abnormal or damaged components of the submerged arc furnace compensation device, manpower and material resources are greatly wasted. Therefore, it can hardly meet the needs of enterprise and society development and the efficiency requirement.

### SUMMARY OF THE INVENTION

To overcome the defects of the existing technology in submerged arc furnace power compensation device, the present invention provides a brand new remote wireless communication control system for submerged arc furnace reactive compensation, which comprises a remote wireless communication control machine and a submerged arc furnace reactive compensation device. The remote wireless communication control machine further includes a MS-RSCM302 safety communication module and a MS-NC2 serial port conversion module. The MS-RSCM302 safety communication module is integrated with a MS-3G network communication module, where this system integrated software can remotely and wirelessly monitor the collection and control of submerged arc furnace. The submerged arc furnace reactive compensation device further includes a control cabinet and a capacitance automatic compensation cabinet. The control cabinet comprises a MS-RSCM302 safety communication module, a MS-NC2 serial port conversion module, a DVPEH2 PLC controller, a programmable multi-function network instrument and a touch screen. The capacitance automatic compensation cabinet comprises multiple compensation units comprising branch fuse 1, current transformer 2, single-phase power capacitor 3, harmonic filter 4, new type switchgroup 5, and branch tripolar air circuit breaker 6 in successive concatenation. After the incoming terminals of the branch tripolar air circuit breaker of the multiple compensation units are connected in parallel, it shall be connected to Phase A or B or C at the secondary outgoing terminal of the transformer of the submerged arc furnace; the terminal of the branch fuse which fails to pass through the current transformer shall be connected to Phase X or Y or Z at the secondary outgoing terminal of the transformer of the submerged arc furnace.

Additionally, the present invention relates to a technical proposal. The technical proposal is to perform data collection & reception and send control instructions to the submerged arc furnace reactive compensation device via the data transmission modes of wired, wireless Internet network or 3G network, with the customized software installed at the terminals of desktop computers, laptops or smart phones, to which the remote wireless communication control device is connected.

Further, the present invention relates to a technical proposal. The technical proposal is to install the MS-RSCM302 security communication module and the MS-NC2 serial port conversion module in the control cabinet of the submerged arc furnace reactive compensation device. The MS-RSCM302 security communication module is capable of sending data of the remote wireless communication controller and receiving control instructions via the data transmission modes of wired, wireless Internet network or 3G network; the MS-NC2 serial port conversion module is connected to the DVPEH2 PLC controller for controlling the programmable multi-function network instrument and the submerged arc furnace reactive compensation device.

Compared with the existing technology, the present invention provides beneficial effects. The present invention combines system integrated software, remote wireless monitoring technology, visualization technology, wireless network transmission technology and industrial automatic control (PLC) system, being capable of remotely and wirelessly monitoring and controlling the monitored object. Thus an industrially safe remote operation guarantee center of equipments can be built to meet the enterprise's requirements for each branch company and branch plant with respect to data collection, centralized monitoring and remote management of various equipment data, thus solving such problems as tedious on-site maintenance, long maintenance time, and unnecessary operation & maintenance burden to the users.

### BRIEF DESCRIPTION OF THE DRAWINGS

FIG. 1 shows the structure diagram of the present invention of remote wireless communication control system for submerged arc furnace reactive compensation.

FIG. 2 shows the circuit diagram of the MS-RSCM302 safety communication module in the present invention of remote wireless communication control system for submerged arc furnace reactive compensation.

FIGS. 3A-3G show the circuit diagram of the MS-3G network communication module in the present invention of remote wireless communication control system for submerged arc furnace reactive compensation.

FIG. 4 shows the circuit diagram of the MS-NC2 serial port conversion module in the present invention of remote wireless communication control system for submerged arc furnace reactive compensation.

FIG. 5 shows the circuit diagram of the DVPEH2 PLC controller in the present invention of remote wireless communication control system for submerged arc furnace reactive compensation.

FIGS. 6A-6N illustrate the schematic circuit diagram of the programmable multi-function network instrument in the present invention of remote wireless communication control system for submerged arc furnace reactive compensation.

FIG. 7 illustrates the schematic circuit diagram of the compensation units of the capacitance automatic compensation cabinet in the present invention of remote wireless communication control system for submerged arc furnace reactive compensation.

FIG. 8 illustrates the layout of the submerged arc furnace compensation device in the present invention of remote wireless communication control system for submerged arc furnace reactive compensation.

### SPECIFIC EMBODIMENTS

Referring to the figures and exemplary embodiments, the present invention is further illustrated as below.

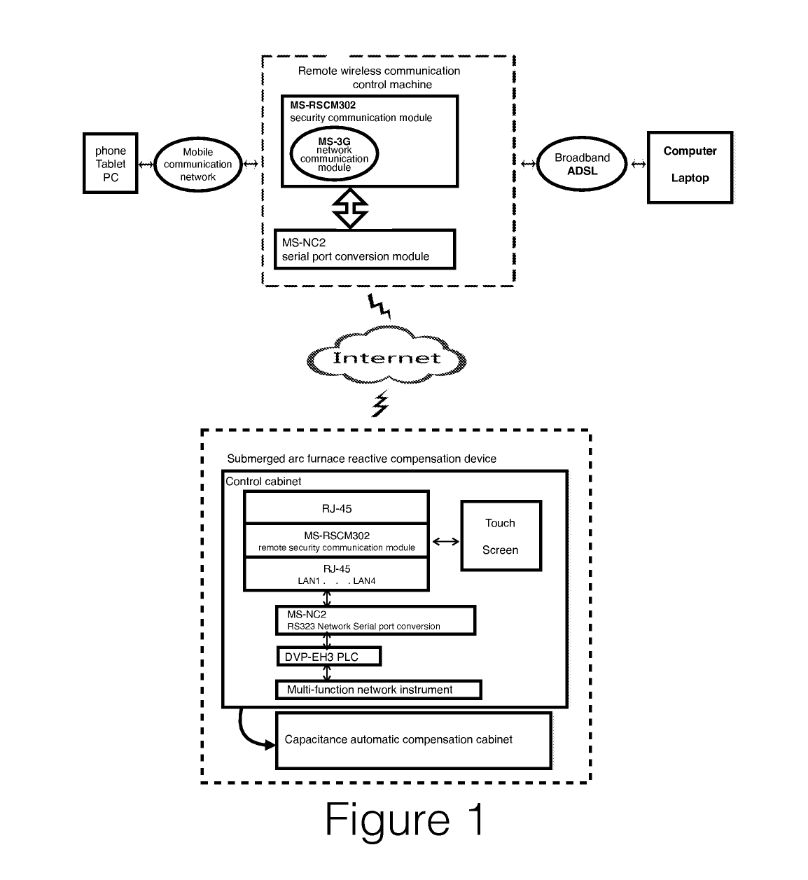

FIG. 1 shows the structure diagram of the present invention of remote wireless communication control system for submerged arc furnace reactive compensation. Through the wired or wireless connection between the remote wireless communication control machine and the terminals of desktop computers, laptops or smart phones, on which the customized professional procedures are applied to control the submerged arc furnace reactive compensation device by adopting Internet network remote wireless communication, it can carry out real-time monitoring, data collection, automatic control, data analysis and processing as well as system operation diagnose, and then perform online testing and automatic adjustment, thus the best control plan will be automatically formed as the reference and choice for the operation personnel.

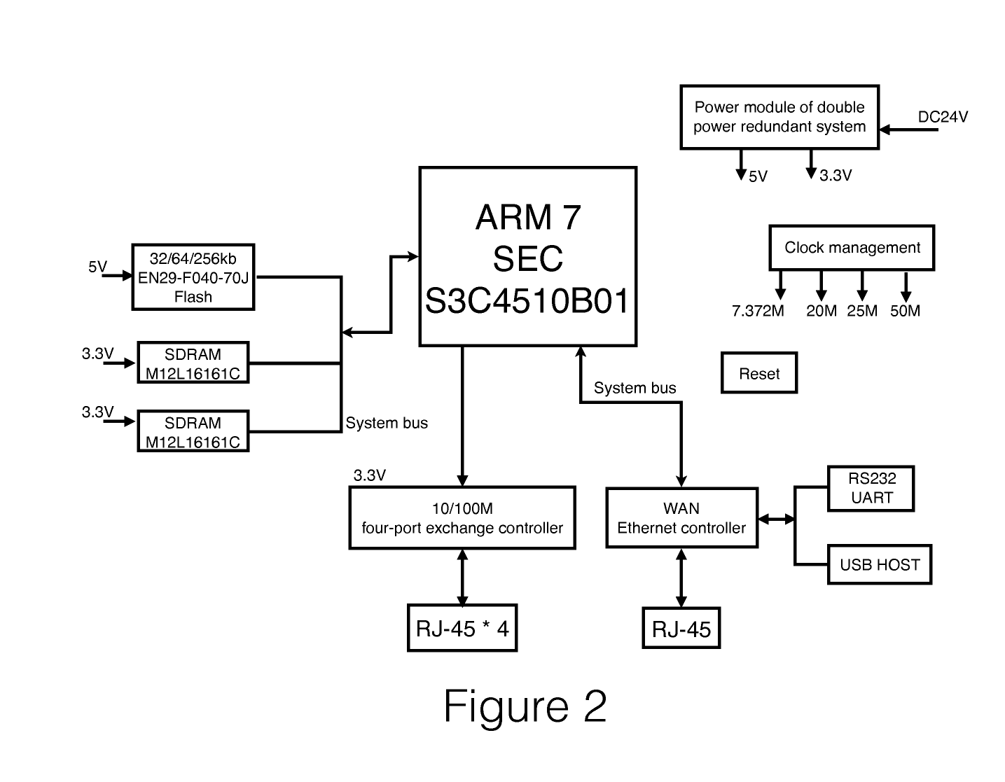

As shown in FIG. 2, ARM7 SEC S3C4510B01 chips are used in the MS-RSCM302 security communication module as its main control chips. Four 10/100 Mbit/s RJ-45 general Ethernet data exchange control interfaces are equipped, with MS-3G network communication modular circuit being integrated as the 3G communication circuit, such that data communication can be connected and realized, thus collecting and sending the customized function command.

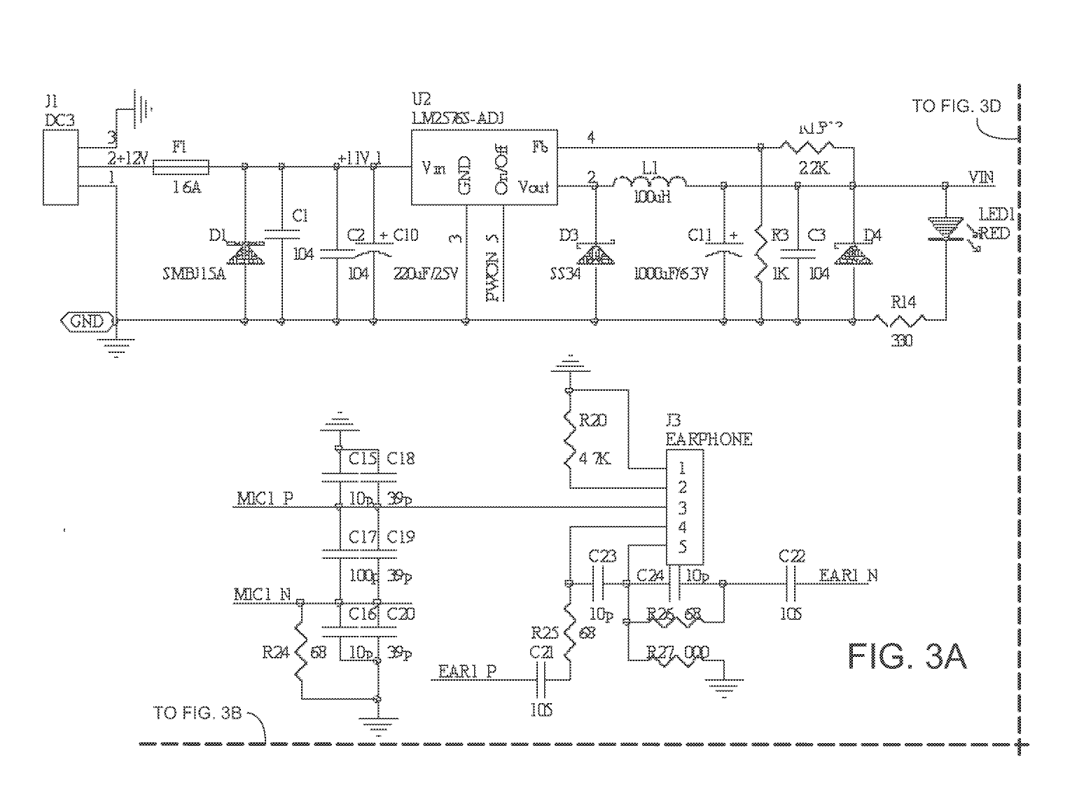

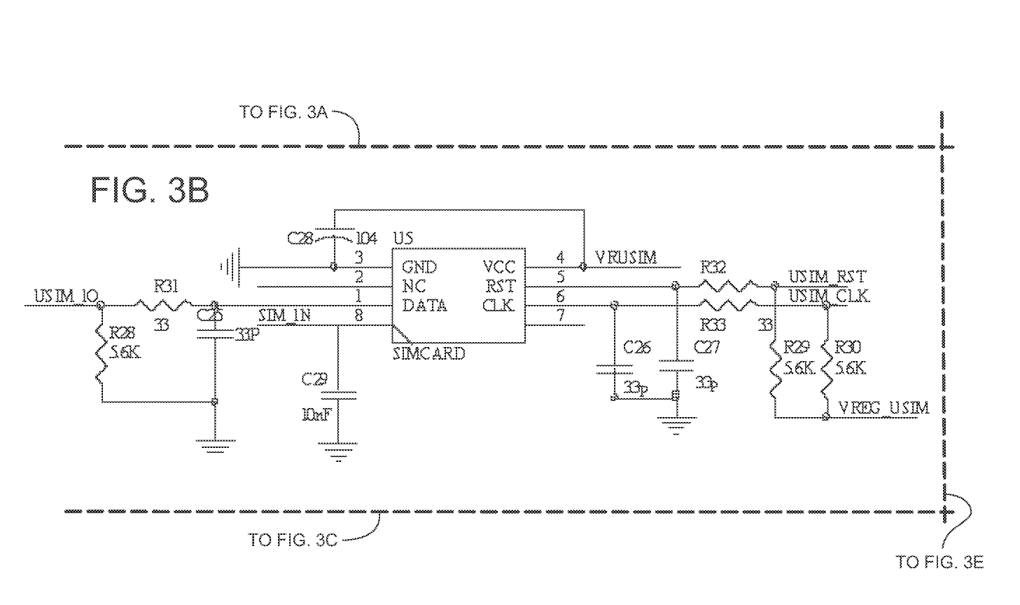

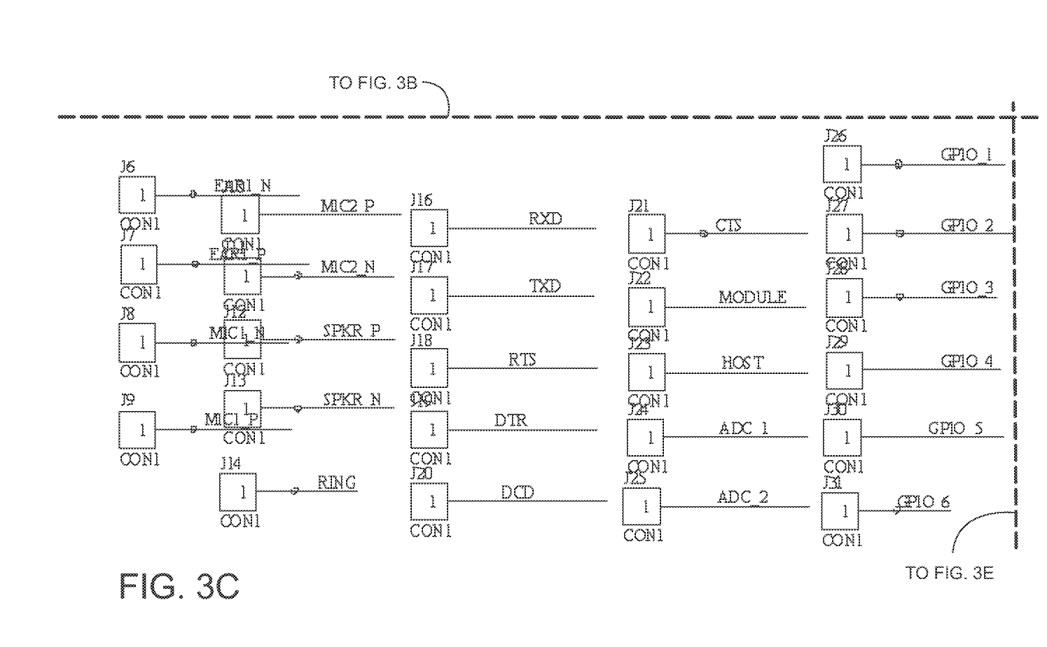

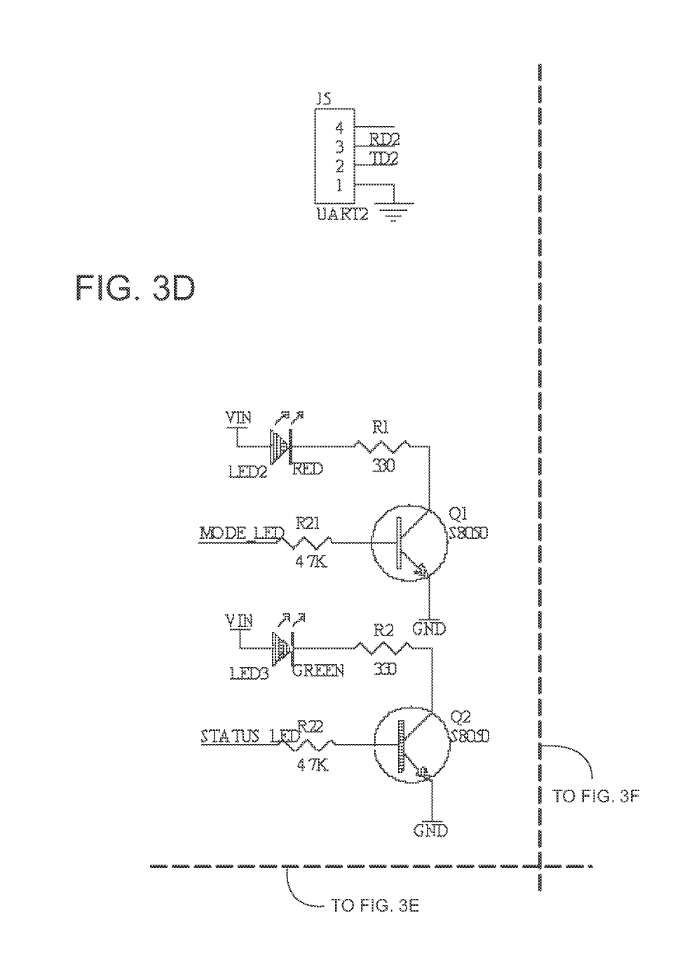

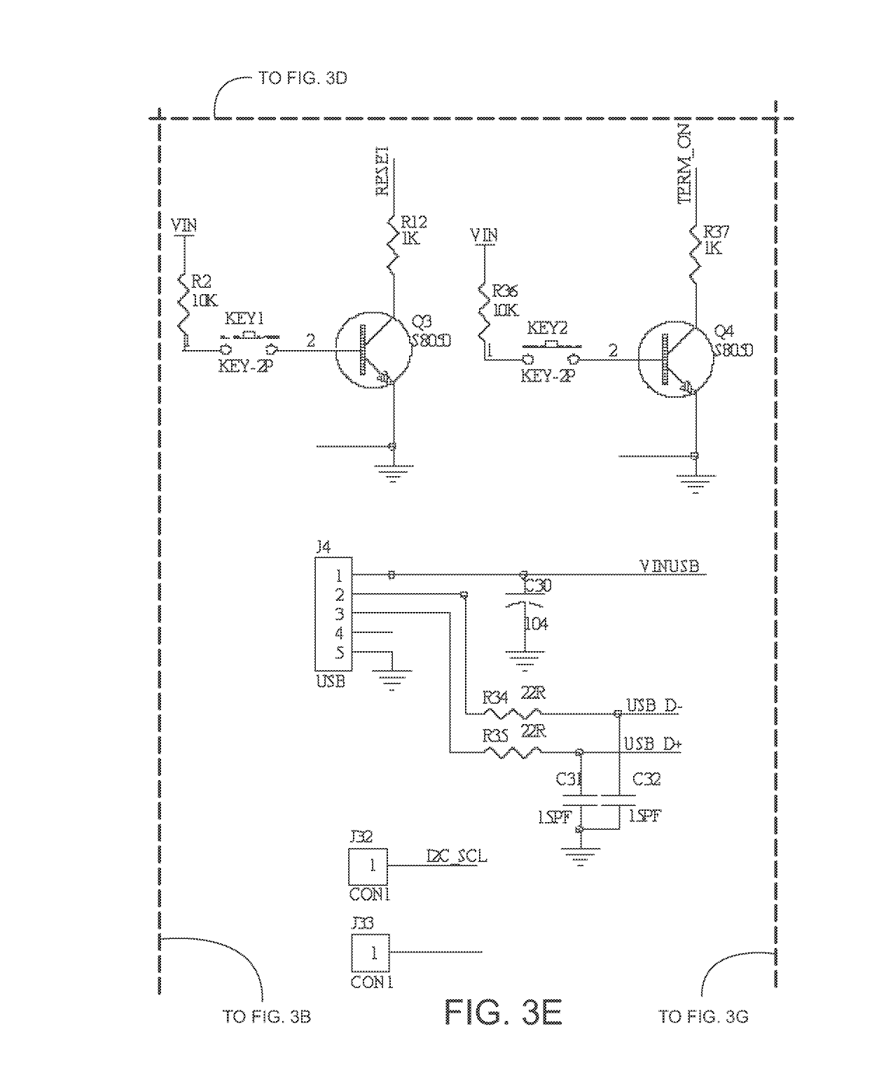

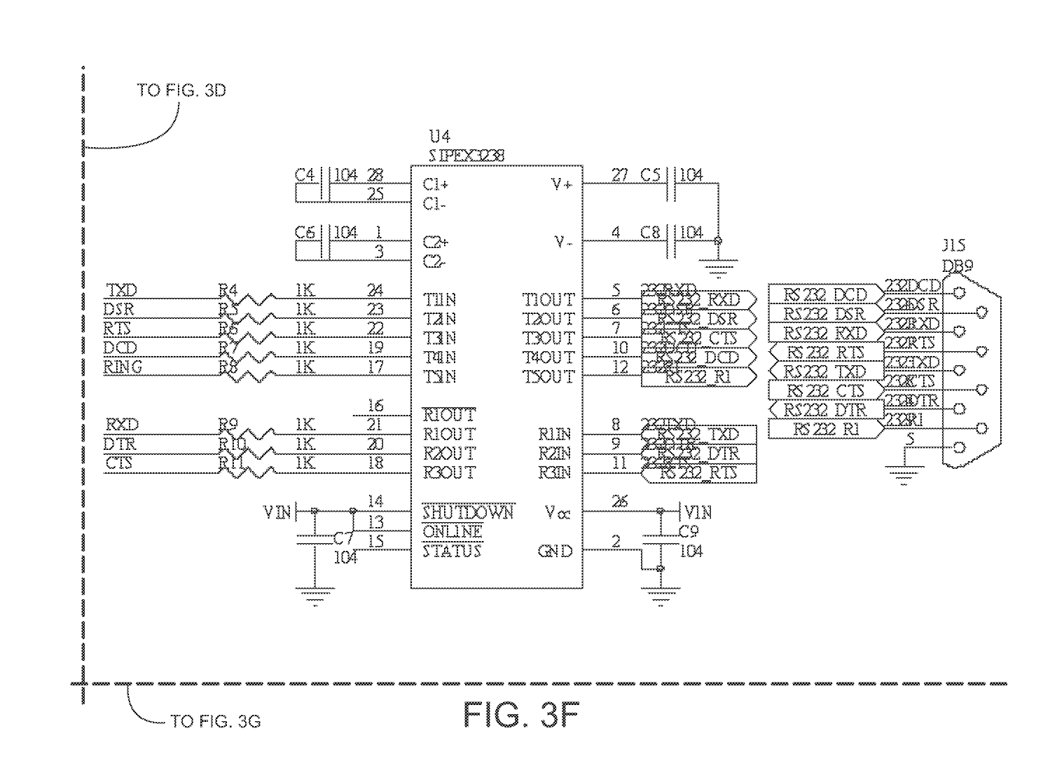

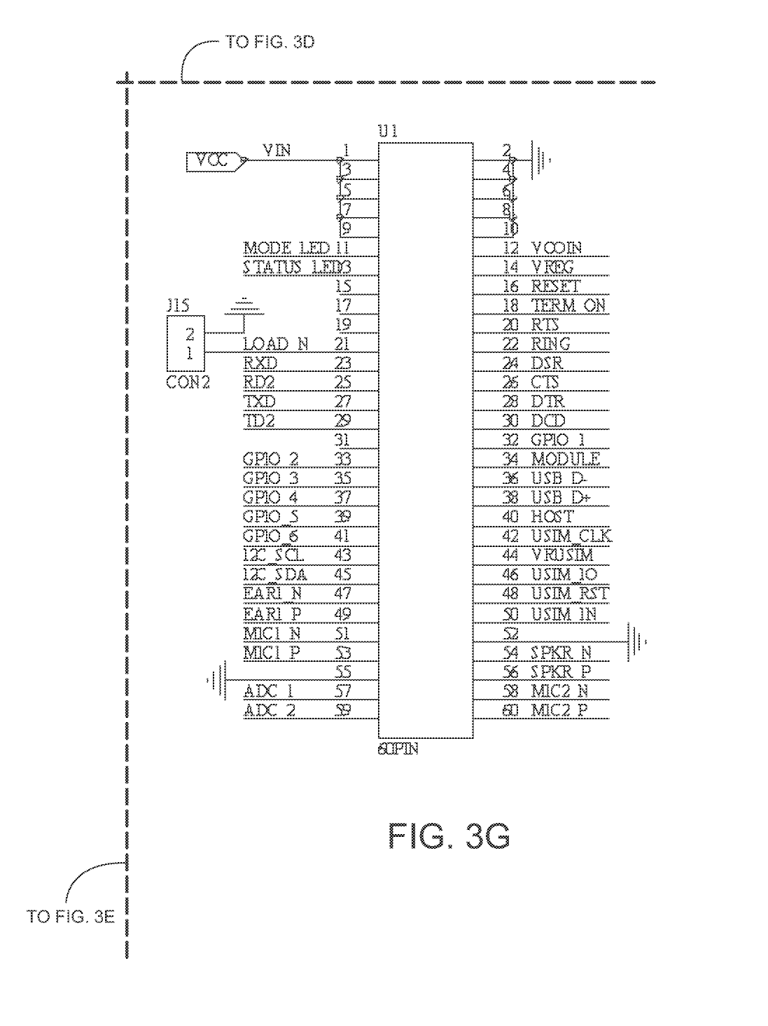

FIGS. 3A-3G show the circuit diagram of the MS-3G network communication module in the present invention of remote wireless communication control system for submerged arc furnace reactive compensation. The modular circuit is designed to connect with the following three system 3G wireless networks: W-CDMA, CDMA2000, and TD-SCDMA. Therefore, as being incapable of normal network communication, the 3G wireless network communication link is available to realize the data communication and customize the function command.

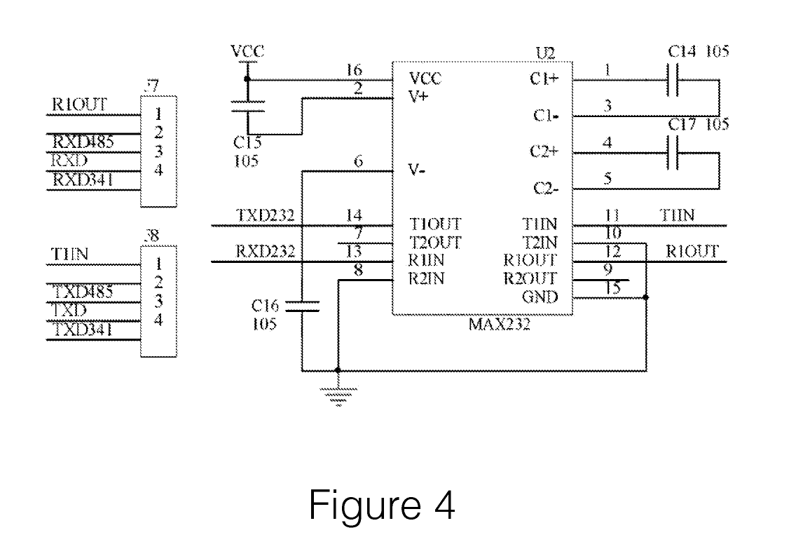

FIG. 4 shows the MS-NC2 serial port conversion module of the present invention of remote wireless communication control system for submerged arc furnace reactive compensation. In the present embodiment, the circuits can be connected and the data can be communicated between the MS-RSCM302 security communication module and the DVPEH2 PLC controller.

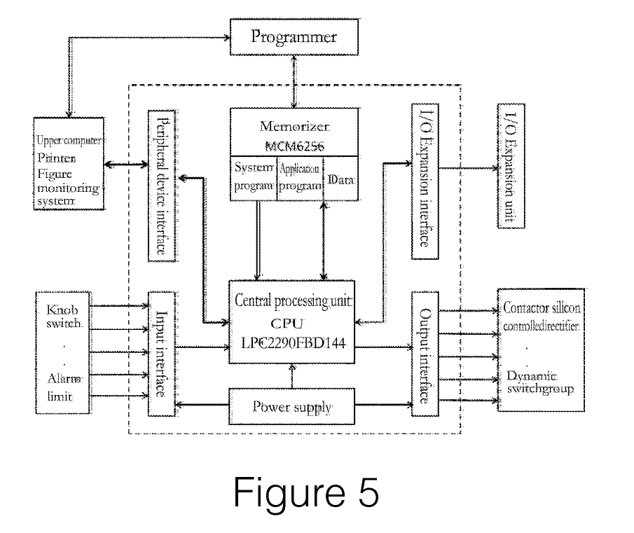

FIG. 5 shows the schematic diagram of the DVPEH2 PLC controller of the present invention of remote wireless communication control system for submerged arc furnace reactive compensation. The PLC2290FBD144 chip is adopted as the CPU chip of the controller and MCM6256 chip as the memorizer, and I/O expansion interface, output/input interfaces and peripheral device interfaces of upper computer are also equipped. In the present embodiment, the circuits can be connected and the data can be communicated between the MS-NC2 serial port conversion module and the programmable multi-function network instrument.

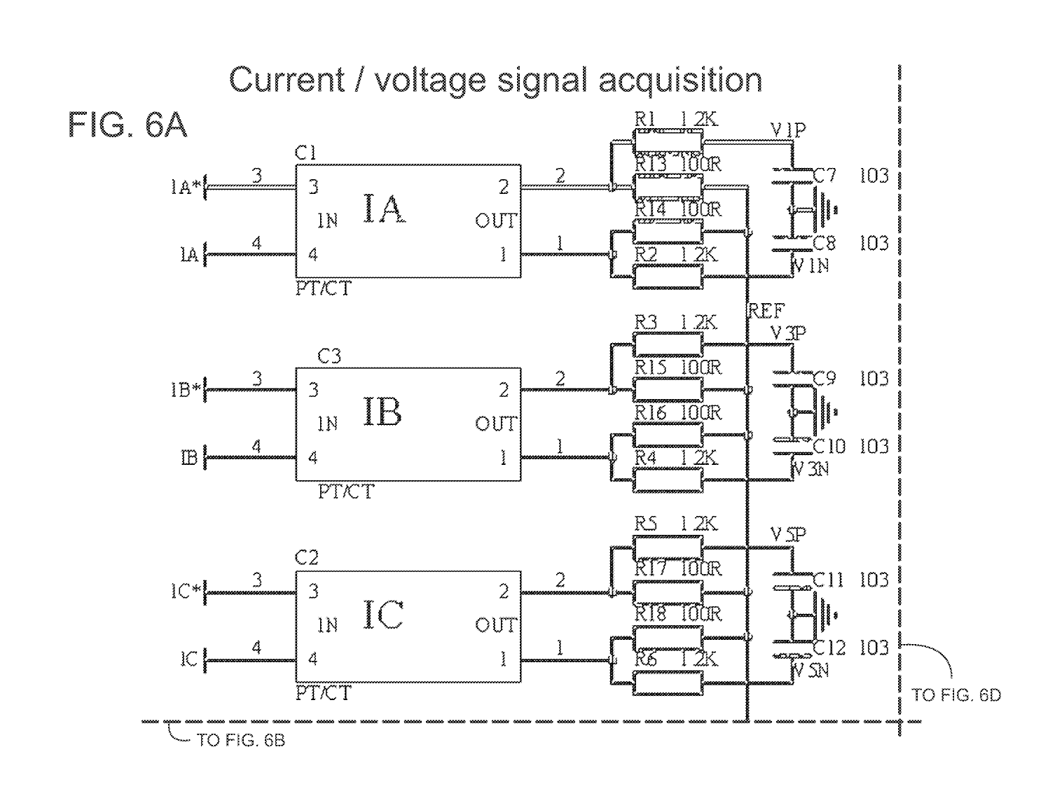

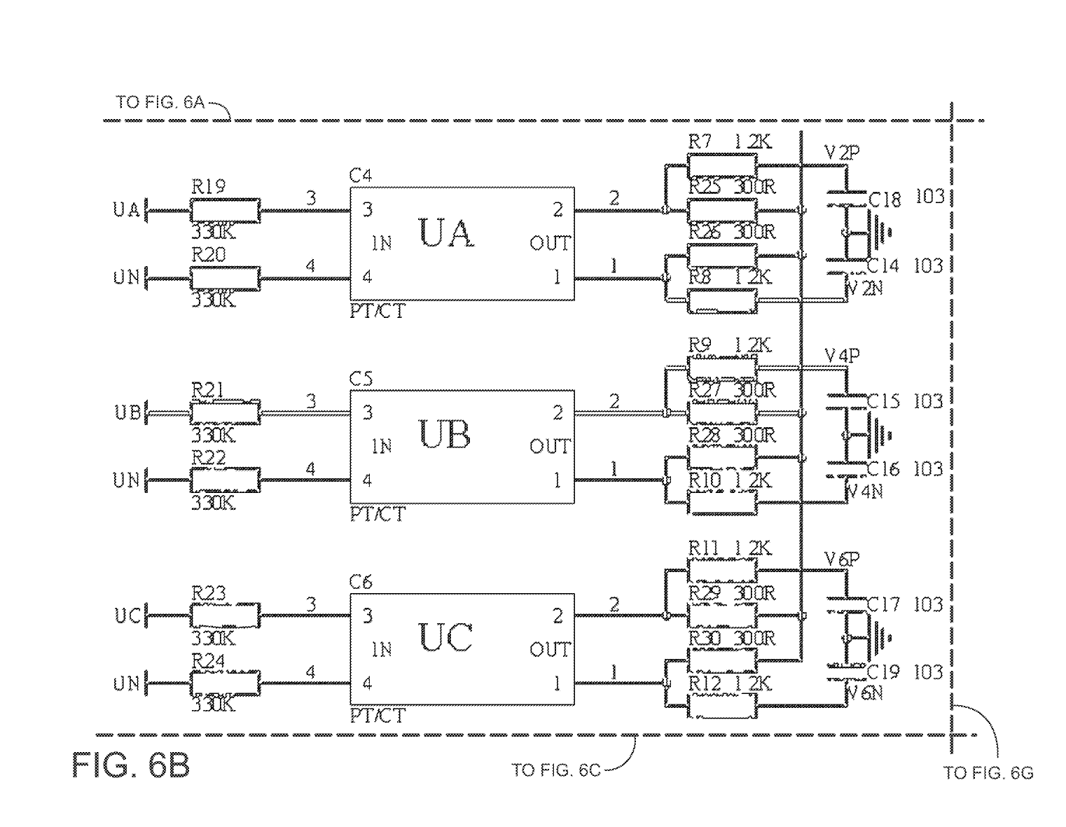

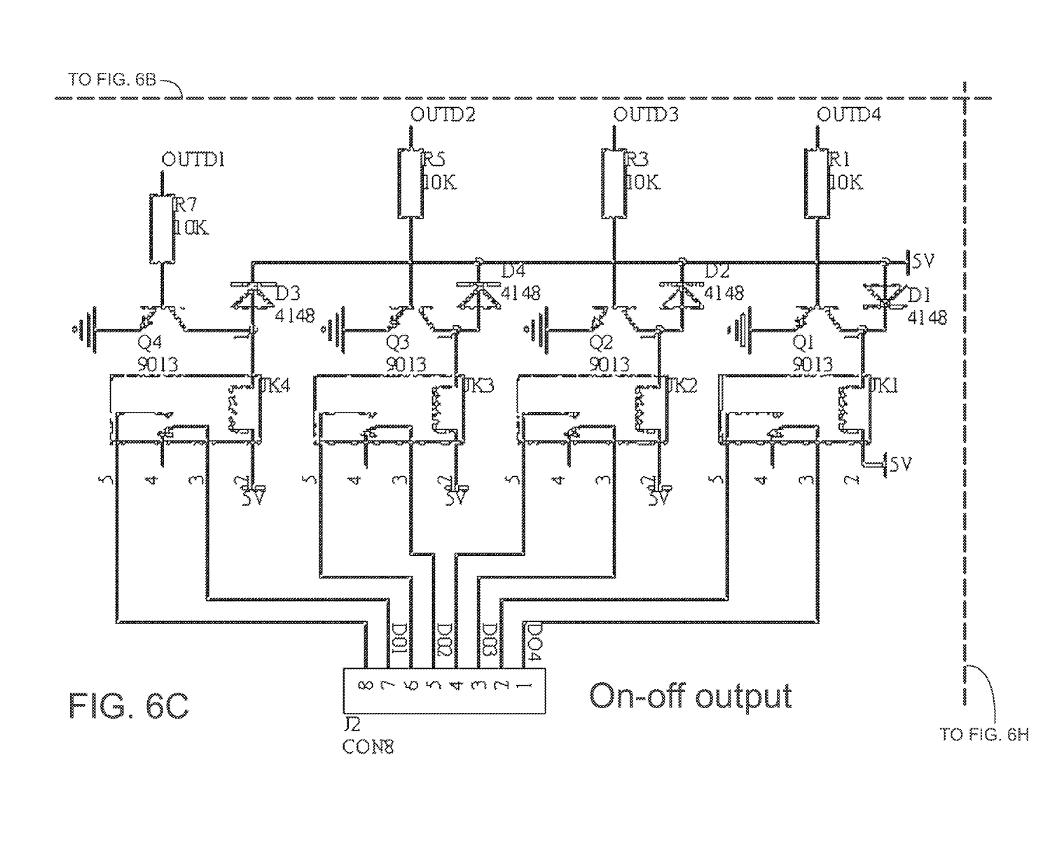

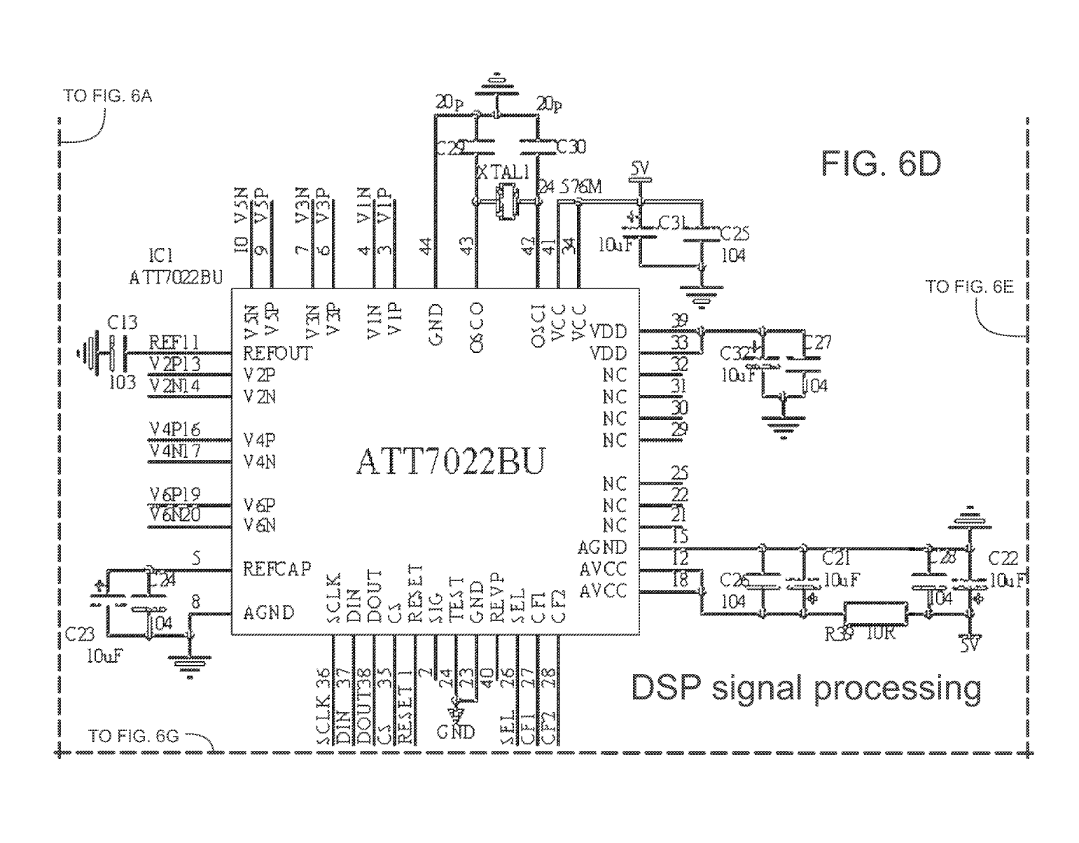

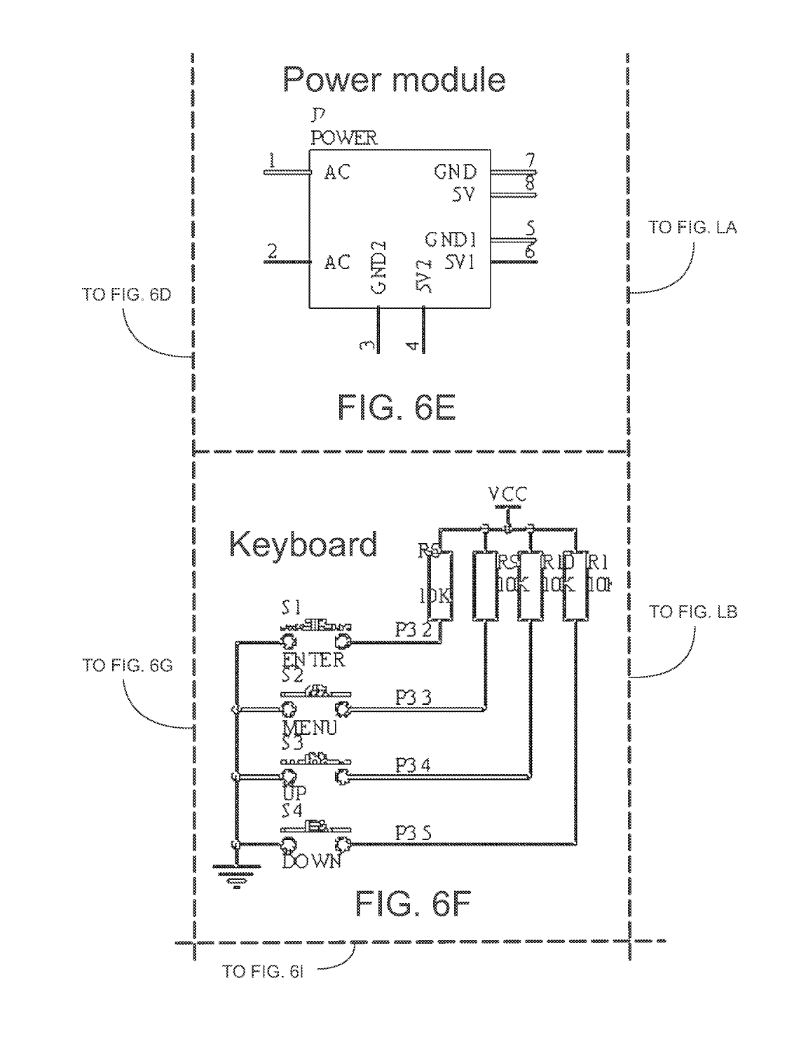

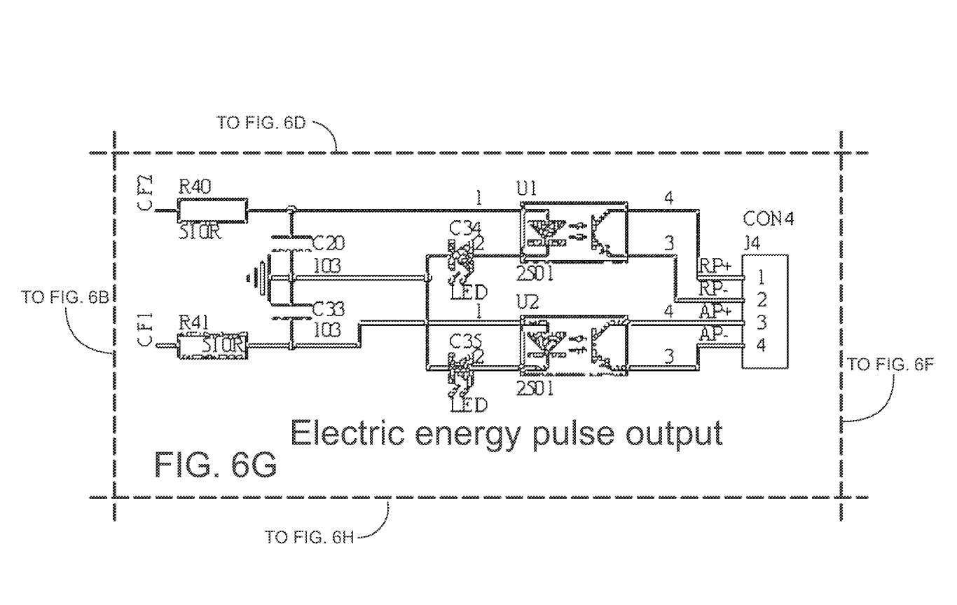

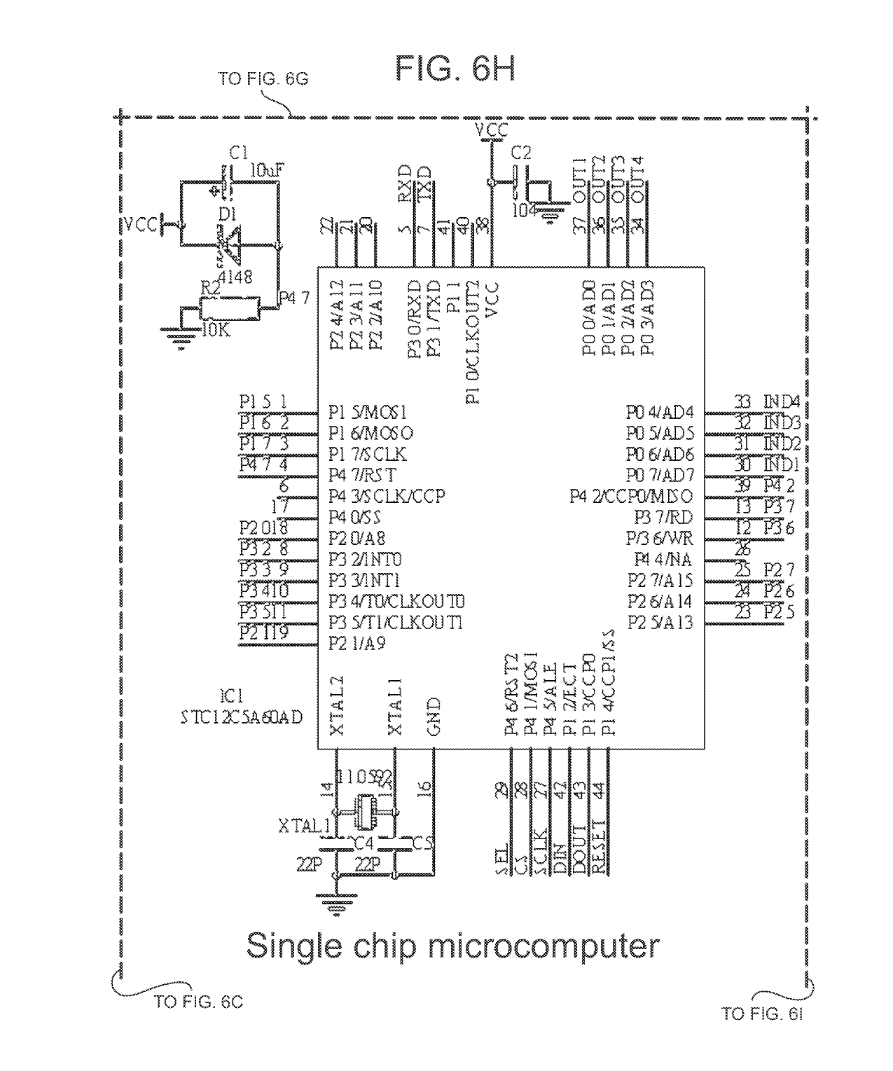

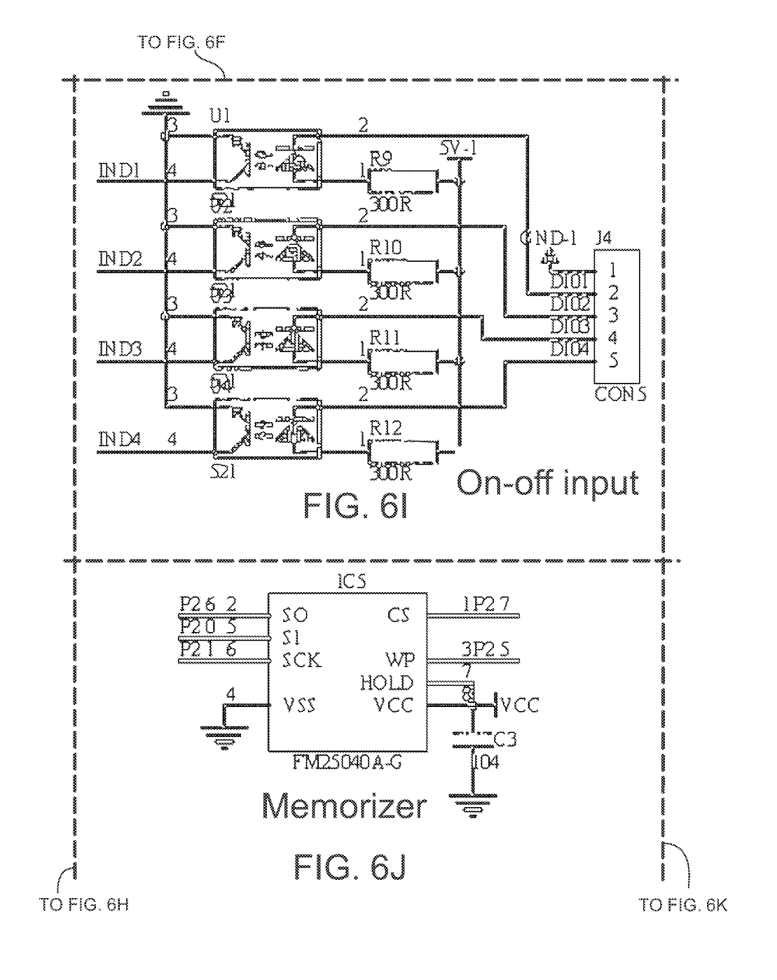

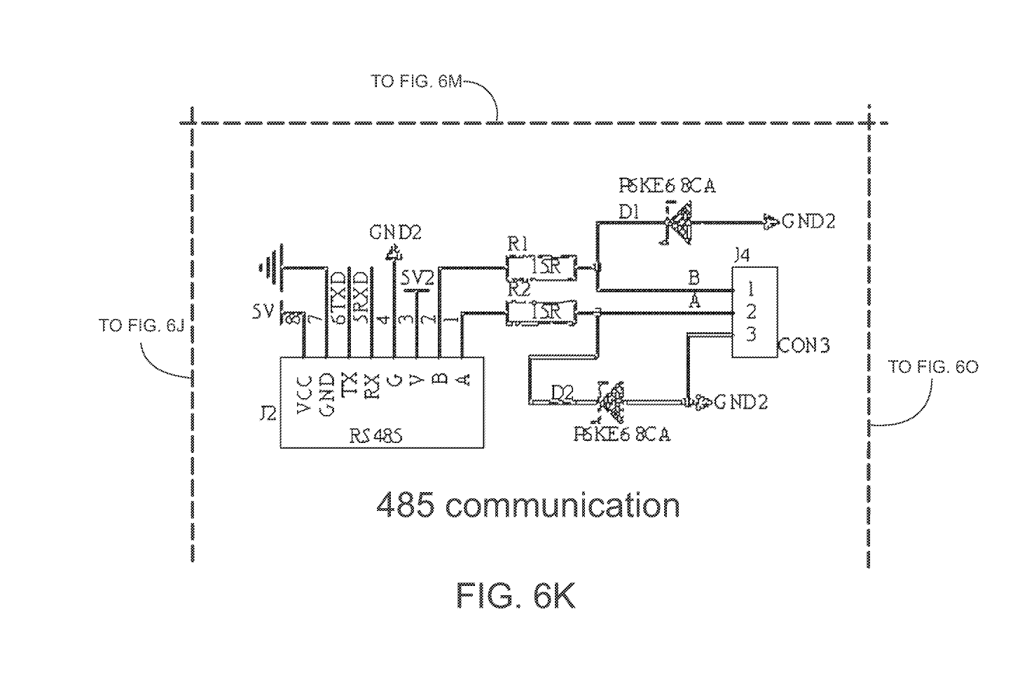

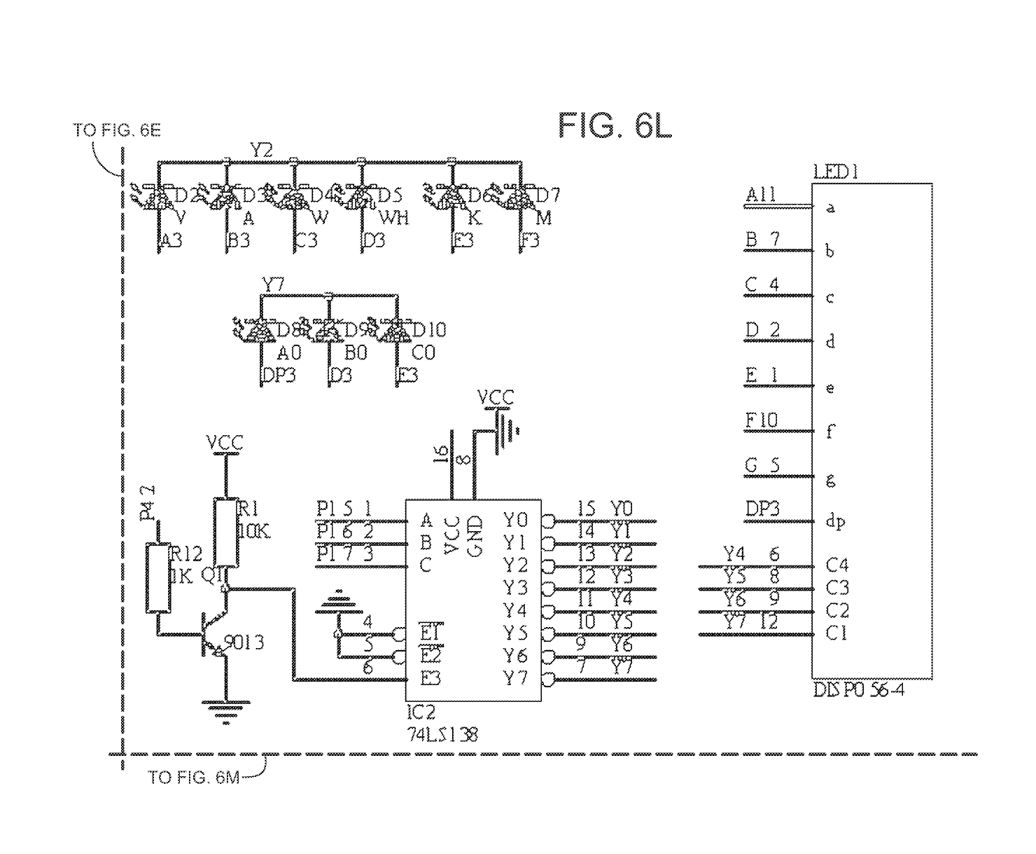

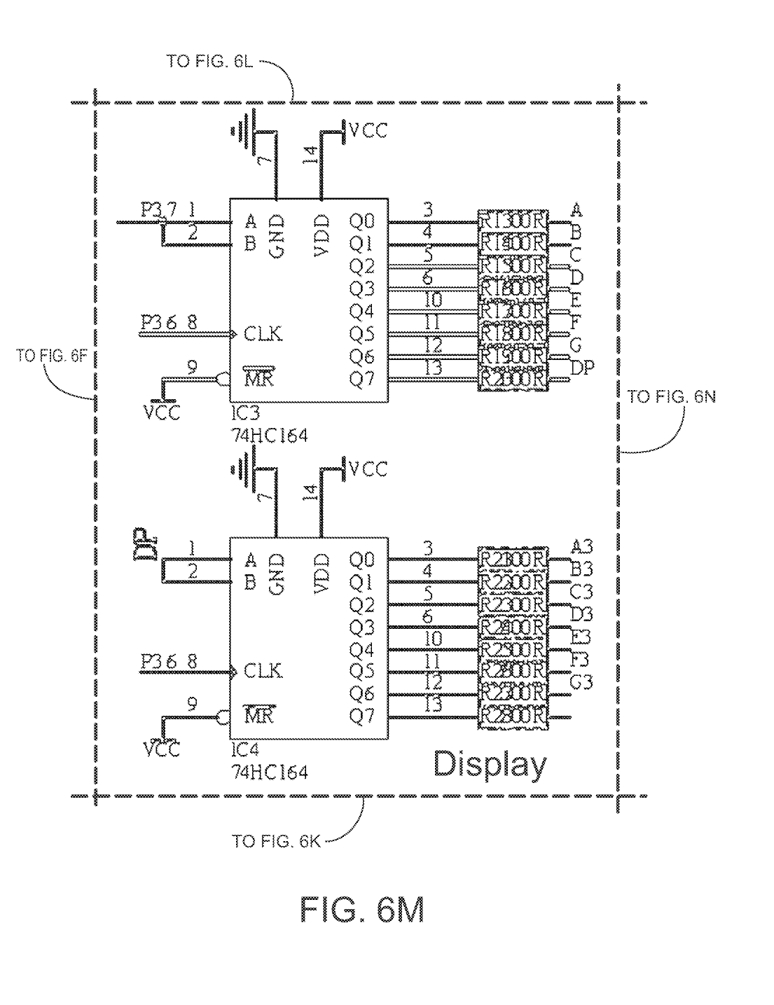

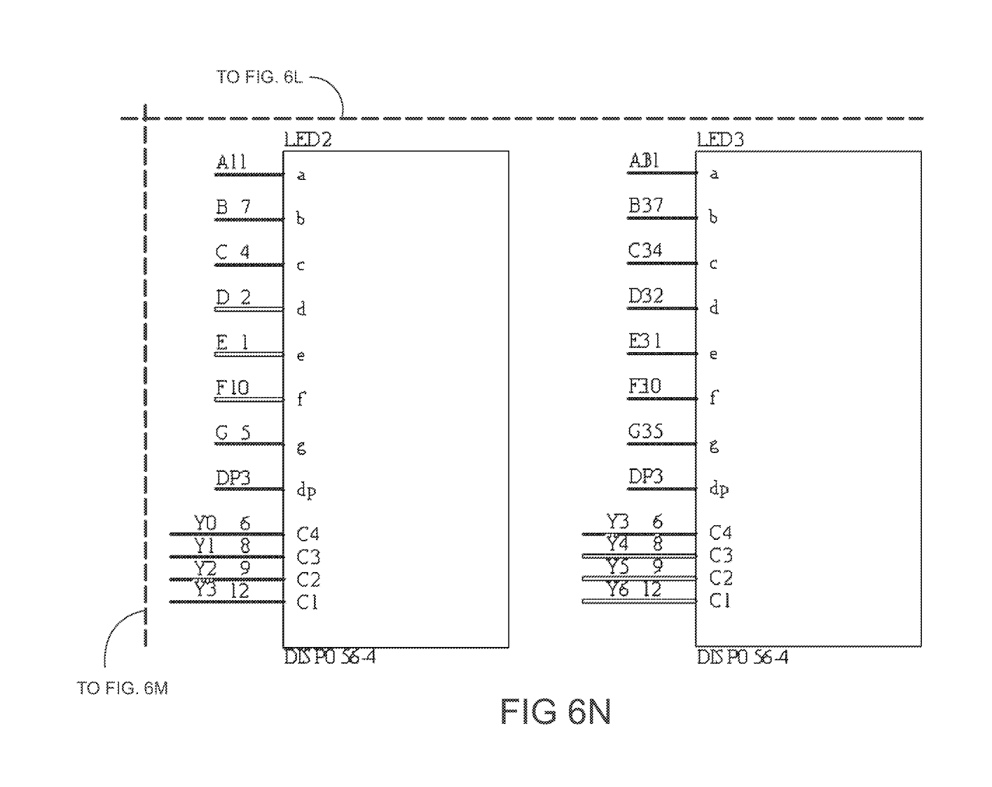

FIGS. 6A-6N illustrate the schematic circuit diagram of the programmable multi-function network instrument in the present invention of remote wireless communication control system for submerged arc furnace reactive compensation. The ATT7022BU chip is adopted in the instrument as its main control signal processing chip, carrying a current/voltage signal acquisition circuit, an electrical energy pulse output circuit, an on-off output circuit, an on-off input circuit, a memorizer chip, and a keyboard and a 485 communication circuit interface. When connecting with the capacitance automatic compensation cabinet of submerged arc furnace, the programmable multi-function network instrument can realize the data monitoring and collection over the working condition of the whole submerged arc furnace and transmit the control command.

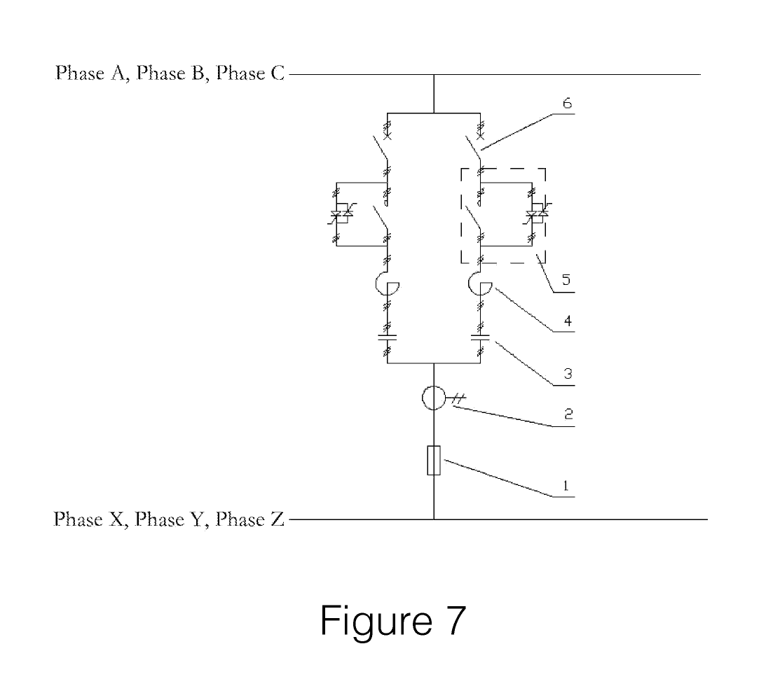

In FIG. 7, the incoming terminal of the branch fuse 1 is connected with Phase X or Phase Y or Phase Z at the secondary outgoing terminal of the submerged arc furnace transformer. The outgoing terminal of the branch fuse 1 passes through the current transformer 2 and connects with one terminal of the one-phase power capacitor 3. The other terminal of the one-phase power capacitor 3 is tandem connected with one terminal of the harmonic filter 4. The other terminal of the harmonic filter 4 is tandem connected with one terminal of the new type switchgroup 5. The other terminal of the new type switchgroup 5 is tandem connected with the outgoing terminal of the branch tripolar air circuit breaker 6. When the incoming terminal of the branch tripolar air circuit breaker is connected in parallel with the incoming terminals of the branch tripolar air circuit breakers of the multiple compensation units, it will be connected with the Phase A, Phase B or Phase C at the secondary outgoing terminal of the submerged arc furnace transformer.

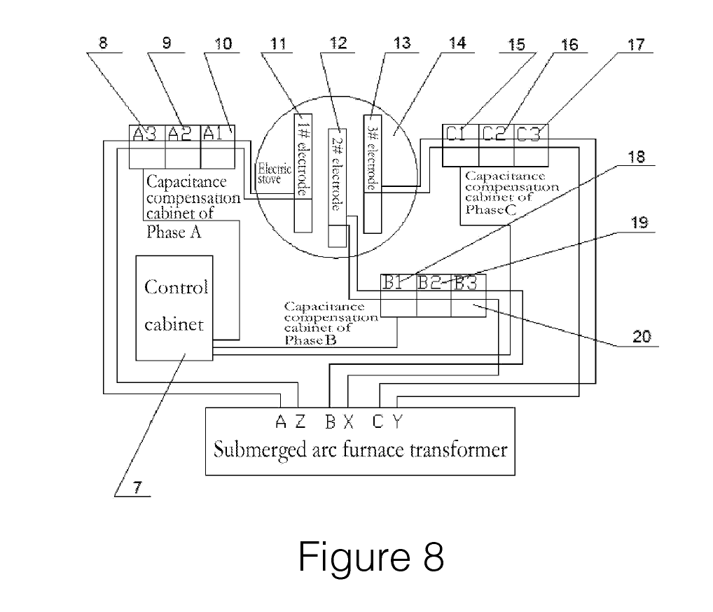

In FIG. 8, flowing cooling liquid is injected inward Phase A, Phase B, Phase C, and Phase X, Phase Y, Phase Z at the secondary low-voltage outgoing terminals of submerged arc furnace transformer 8 respectively to facilitate the heat-generating copper tube connecting with the incoming terminals of the three capacitance automatic dynamic compensation cabinets 8, 9, 10 of Phase A, the three capacitance automatic dynamic compensation cabinets 18, 19, 20 of Phase B and the three capacitance automatic dynamic compensation cabinets 15, 16, 17 of Phase C. While the outgoing terminals of the capacitance automatic dynamic compensation cabinets of Phase A, Phase B and Phase C are connected with the three electrodes of submerged arc furnace 14, i.e. 1# electrode 11, 2# electrode 12, 3# electrode 13. In the control cabinet 7, the secondary control circuit is connected with the capacitance automatic compensation cabinet.

With respect to the present invention of remote wireless communication control system for submerged arc furnace reactive compensation, such internet ways as wired broadband ADSL, wireless transmission and 3G are adopted to conduct remote Internet communication and data collection. Through installation of customized software at the terminals of desktop computers, laptops, tablet PC and smart phones, each site can be remotely monitored online and relevant production data can be read, thus realizing remote wireless monitoring, control or management for the power supply condition of the submerged arc furnace reactive compensation device and the actual operational states of the submerged arc furnace. The simple operation not only improves the operation and use efficiency and makes the maintenance convenient, but also has increased the operational randomicity, and helps solving such problems as tedious on-site maintenance, long maintenance time, and unnecessary operation & maintenance burden to the users.

We claim:

1. A remote wireless communication control system of submerged arc furnace reactive compensation comprising: a remote wireless communication control machine and a submerged arc furnace reactive compensation device.

2. The remote wireless communication control system of submerged arc furnace reactive compensation of claim 1, wherein the remote wireless communication control machine further comprises a MS-RSCM302 security communication module integrated with a MS-3G network communication module, and a MS-NC2 serial port conversion module, to remotely and wirelessly monitor the collection and control of the submerged arc furnace though the system integrated software.

3. The remote wireless communication control system of submerged arc furnace reactive compensation of claim 1, wherein the submerged arc furnace reactive compensation device further comprises a control cabinet and a capacitance automatic compensation cabinet.

4. The remote wireless communication control system of submerged arc furnace reactive compensation of claim 3, the control cabinet further comprising a MS-RSCM302 security communication module, a MS-NC2 serial port conversion module, a DVPEH2 PLC controller, a programmable multi-function network instrument and a touch screen; and the capacitance automatic compensation cabinet further comprising multiple compensation units.

5. The remote wireless communication control system of submerged arc furnace reactive compensation of claim 1, further comprising performing data collection & reception and sending control instructions to the submerged arc furnace reactive compensation device via the data transmission modes of wired, wireless Internet network or 3G network, with the customized software installed at the terminals of desktop computers, laptops or smart phones, to which the remote wireless communication control device is connected.

6. The remote wireless communication control system of submerged arc furnace reactive compensation of claim 3, further comprising installing the MS-RSCM302 security communication module and the MS-NC2 serial port conversion module in the control cabinet. The MS-RSCM302 security communication module is capable of sending data of the remote wireless communication controller and receiving control instructions via the data transmission modes of wired, wireless Internet network or 3G network; the MS-NC2 serial port conversion module is connected to the DVPEH2 PLC controller for controlling the programmable multi-function network instrument and the submerged arc furnace reactive compensation device.
